(19) United States
(12) Patent Application Publication
(10) Pub. No.: US 2026/0246133 A1
(43) Pub. Date: Aug. 20, 2026

(54) LENS ASSEMBLY AND WIRELESS ELECTRONIC DEVICE COMPRISING THE SAME

(71) Applicant: GOERTEK INC., Weifang, Shandong (CN)

(72) Inventors: Kenichiro KODAMA, Weifang, Shandong (CN); Katsumi SAITO, Weifang, Shandong (CN); Katsunori ISHIMIYA, Weifang, Shandong (CN)

(21) Appl. No.: 19/159,854

(22) PCT Filed: May 18, 2023
(86) PCT No.: PCT/CN2023/094979

§ 371 Date: Aug. 26, 2025

(51) Int. Cl. H01Q 1/12; G02B 27/01; H01Q 5/20

(52) U.S. Cl. CPC H01Q 1/1271; G02B 27/0172; H01Q 5/20; G02B 2027/0178

(57) ABSTRACT

A lens assembly of a wireless electronic device, comprising: a first lens, configured to provide a field of view (FOV) of a real world to an eye of a user, where the first lens has a first surface and a second surface that are opposite to each other; a first film disposed on the first surface, where the first film comprises a first antenna electrode, and the first antenna electrode is at least partially located within the FOV and serves at least a part of a first antenna of the wireless electronic device; and a frame, configured to support the first lens at a body of the user. A quality of wireless communication is improved.

### TECHNICAL FIELD

The present disclosure relates to the technical field of wireless communications, and in particular to a lens assembly and a wireless electronic device comprising the lens assembly.

### BACKGROUND

Recent decades have witnessed prosperity of electronic wearable devices. Being designed properly, these devices are generally not handheld during usage, but are “worn” as accessories or even apparel on body parts of a user, i.e. a wearer. Hence, it is quite convenient for the wearer to interact with the outside world simultaneously in various manners. For example, the virtual reality (VR) or augmented reality (AR) technology may apply electronic headwear to provide visual and/or acoustic information, while the wearer is able to operate a keyboard or a gamepad by hand. For another example, an electronic wristband may collect electro-cardio signals of the wearer, while not interrupting daily activities of the wearer. For another example, electronic eyeglasses may prompt the wearer with detailed content of instant messages, even when both bands of the wearer are occupied. Since visual signals are almost the most common among all kinds of information received by human beings, many electronic wearable devices are head-mounted and adapted to user's vision, so as to facilitate interaction with the user's eyes.

Rapid development of the batteries and the integrated circuits renders electronic wearable devices smaller sizes and more compact structures, which aims at merging them into each application scenario in people's daily life. Therefore, an increasing requirement on convenient “anytime and anywhere” accesses to the Internet and WLANs demands the electronic wearable devices wireless and portable. A prospect is that the electronic wearable devices are capable to provide high-quality wireless accesses while not causing an impact on an electromagnetic environment of other components in the device. For example, an AR/VR head-mounted display is desired to be no larger and no heavier than ordinary eyeglasses or goggles. Such objective raises great challenges on a robust design of the electronic wearable devices, especially the wireless ones.

### SUMMARY

In view of the above, a lens assembly and a wireless electronic device comprising the lens assembly are provided according to embodiments of the present disclosure. Quality of the wireless communications can be improved due to a more flexible arrangement of an antenna of the wireless electronic device.

Following technical solutions are provided to achieve the above technical objective.

In a first aspect, a lens assembly of a wireless electronic device, comprising: a first lens, configured to provide a field of view (FOV) of a real world to an eye of a user, where the first lens has a first surface and a second surface that are opposite to each other; a first film disposed on the first surface, where the first film comprises a first antenna electrode, and the first antenna electrode is at least partially located within the FOV and serves at least a part of a first antenna of the wireless electronic device; and a frame, configured to support the first lens at a body of the user.

In an embodiment, the first film is transparent or translucent.

In an embodiment, the frame is configured to keep the first antenna electrode within a range between the eye and a near point of the eye.

In an embodiment, the first antenna electrode is configured to be located at a portion, which is away from the body among the first film located within the FOV, when the first lens provides the FOV.

In an embodiment, the first surface is configured to be located farther from the eye than the second surface when the first lens provides the FOV.

In an embodiment, the first film further comprises a substrate, and the first antenna electrode is a conductive pattern which is embedded in the substrate or disposed on a surface of the substrate facing first lens.

In an embodiment, a whole of the frame is made of a conductive material.

In an embodiment, the frame comprises a first part made of a conductive material and a second part made of a non-conductive material, and an area of the second part is smaller than an area of the first antenna electrode.

In an embodiment, the lens assembly further comprises: RF circuitry, electrically connected to the first antenna electrode; and one or both of: a communication cable, electrically connected between the RF circuitry and the first antenna electrode; and an impedance matcher, electrically connected between the RF circuitry and the first antenna electrode, where the impedance matcher is configured to suppress impedance mismatch between the first antenna and the RF circuitry; where the one of both of the communication cable and the impedance matcher is covered by the frame.

In an embodiment, the one of both of the communication cable and the impedance matcher are at least partially located at an edge surface connecting the first surface and the second surface, or an edge portion of the first surface or the second surface.

In an embodiment, the lens assembly further comprises: a second film located on the second surface, where the second film comprises a second antenna electrode, and the second antenna electrode is at least partially located within the FOV.

In an embodiment, the second antenna electrode serves as another part of the first antenna, or at least a part of a second antenna.

In an embodiment, the first antenna electrode and the second antenna electrode do not overlap in a direction of the eye perceiving the FOV.

In an embodiment, the lens assembly further comprises a waveguide, where: the waveguide is attached to the first lens and at least partially disposed within the FOV; and the waveguide is configured to receive a light signal projected on a part of the waveguide to form an image perceivable to the eye of the user.

In an embodiment, the first film is located between the waveguide and the first lens.

In an embodiment, the lens assembly further comprises a second lens attached to the waveguide, where the second lens is at least partially located within the FOV, and the waveguide is located between the first lens and the second lens.

In an embodiment, the first lens is located farther from the eye than the second lens when providing the FOV.

In an embodiment, the lens assembly further comprises a third film located on a third surface of the second lens, where the second lens have the third surface and a fourth surface that are opposite to each other, the third film comprises a third antenna electrode, and the third antenna electrode is at least partially located within the FOV.

In an embodiment, the third antenna electrode serves as: another part of the first antenna; another part of the second antenna, in a case that the lens assembly comprises the second film; or at least a part of a third antenna.

In an embodiment, the first antenna electrode and the third antenna electrode do not overlap in a direction of the eye perceiving the FOV.

In a second aspect, a wireless electronic device is provided, comprising at least one lens assembly, each of which is the forgoing lens assembly.

In an embodiment, the wireless electronic device further comprises: housing configured to fix or accommodate the at least one lens assembly, where a whole of the housing is made of a conductive material.

In an embodiment, in a case that two of the at least one lens assembly share the RF circuitry, the RF circuitry is located between the two of the at least one lens assembly.

In an embodiment, the first antenna of one of the at least one lens assembly and the first antenna of another of the at least one lens assembly are configured to transmit or receive wireless signals of different frequency bands.

Therefore, the antenna assembly and the wireless electronic device comprising the same are provided according to embodiments of the present disclosure. The lens assembly comprises the first lens configured to provide the FOV of the real world to the eye of the user, and the first lens has the first surface and the second surface that are opposite to each other. The lens further comprises the first film disposed on the first surface, the first film comprises the first antenna electrode, and the first antenna electrode is at least partially located within the FOV and serves at least the part of the first antenna of the wireless electronic device. The lens further comprises the frame, which is configured to support the first lens at the body of the user. Since the first lens serves as a means of providing the FOV of the real world, the first antenna electrode located on the surface of the first lens is scarcely occluded by the frame of the lens assembly and housing of wireless device, which improves a quality of the wireless communication. It is particularly beneficial when the frame and/or the housing are made of a conductive material.

### BRIEF DESCRIPTION OF THE DRAWINGS

For clearer illustration of the technical solutions according to embodiments of the present disclosure or conventional techniques, hereinafter briefly described are the drawings to be applied in embodiments of the present disclosure or conventional techniques. Apparently, the drawings in the following descriptions are only some embodiments of the present disclosure, and other drawings may be obtained by those skilled in the art based on the provided drawings without creative efforts.

FIG. 1 is a schematic structural diagram of a lens assembly according to an embodiment of the present disclosure.

FIG. 2 is a schematic structural diagram of a lens assembly according to another embodiment of the present disclosure.

FIG. 3 is a schematic structural diagram of a lens assembly according to another embodiment of the present disclosure.

FIGS. 4a and 4b are schematic structural diagrams of a first film according to embodiments of the present disclosure.

FIGS. 5a and 5b are schematic structural diagrams of a lens assembly according to other embodiments of the present disclosure.

FIG. 6 is a schematic structural diagram of a lens assembly according to another embodiment of the present disclosure.

FIGS. 7a and 7b are schematic structural diagrams showing positional relationship between antenna electrodes of a lens assembly according to embodiments of the present disclosure.

FIG. 8 is a schematic structural diagram of a lens assembly according to another embodiment of the present disclosure.

FIG. 9 is a schematic structural diagram of a lens assembly according to another embodiment of the present disclosure.

FIG. 10 is a schematic structural diagram of a lens assembly according to another embodiment of the present disclosure.

FIG. 11 is a schematic structural diagram of a lens assembly according to another embodiment of the present disclosure.

FIG. 12 is a schematic structural diagram showing positional relationship between antenna electrodes of a lens assembly according to another embodiment of the present disclosure.

FIG. 13 is a schematic diagram of a part of a lens assembly in smart eyeglasses according to another embodiment of the present disclosure.

### DETAILED DESCRIPTION OF THE EMBODIMENTS

Hereinafter technical solutions in embodiments of the present disclosure are described in conjunction with the drawings in embodiments of the present disclosure. The described embodiments are only some rather than all of the embodiments of the present disclosure. Any other embodiments obtained based on the embodiments of the present disclosure by those skilled in the art without any creative effort fall within the scope of protection of the present disclosure.

The relationship terms such as “first”, “second” and the like are only used herein to distinguish one entity or operation from another, rather than to necessitate or imply that an actual relationship or order exists between the entities or operations. Furthermore, the terms such as “include”, “comprise” or any other variants thereof means to be non-exclusive. Therefore, a process, a method, an article or a device including a series of elements include not only the disclosed elements but also other elements that are not clearly enumerated, or further include inherent elements of the process, the method, the article or the device. Unless expressively limited, the statement “including a . . . ” does not exclude the case that other similar elements may exist in the process, the method, the article or the device other than enumerated elements.

As described in the background, a requirement on the wireless and portable electronic wearable devices demands a compact design of components within the devices. Particularly, such requirement becomes stricter for a head-mounted electronic device, because a bulky and heavy head-mounted device would not only cause inconvenience during usage but also brings health risks, especially aggravating neck pains. Consequently, many wireless wearable electronic devices try to dispose every component as close as possible to the user's body, such that the users would experience less discomforts due to the imbalanced additional weight when walking, jogging, or simply moving during usage. In one aspect, such design increases interference between an antenna and other components, and thereby degrades a quality of wireless communications. The degradation is exacerbated when housing of the electronic device is made of a conductive material, such as metal, which induces electromagnetic shielding. In such case, the housing is forced to have a non-conductive portion to provide a “window” that allows wireless signals to pass, which complicates manufacturing. In another aspect, such design brings the antenna quite close to a body of the user. For example, an antenna of electronic eyeglasses is disposed at a tip or an intermediate part of temple bar, which is close to an ear or a temple of the user. Since the human body creates an inductance of approximately 500 nH to 750 nH, it attenuates electromagnetic waves and results in reduced intensities and increased bit error rates of wireless signals that are transmitted or received by the antenna. Consequently, the wireless communication of the head-mounted electronic device is further degraded.

In order to address the above technical issue, a lens assembly of a wireless electronic device is provided according to embodiments of the present disclosure. The lens assembly comprises a first lens configured to provide a field of view (FOV) of a real world to an eye of a user, and the first lens has a first surface and a second surface that are opposite to each other. The lens further comprises a first film disposed on the first surface, the first film comprises a first antenna electrode, and the first antenna electrode is at least partially located within the FOV and serves at least a part of a first antenna of the wireless electronic device. The lens further comprises a frame, which is configured to support the first lens at a body of the user. Since the first lens serves as a means of providing the FOV of the real world, the first antenna electrode located on the surface of the first lens is scarcely occluded by the frame of the lens assembly and housing of wireless device, which improves a quality of the wireless communication. It is particularly beneficial when the frame and/or the housing are made of a conductive material.

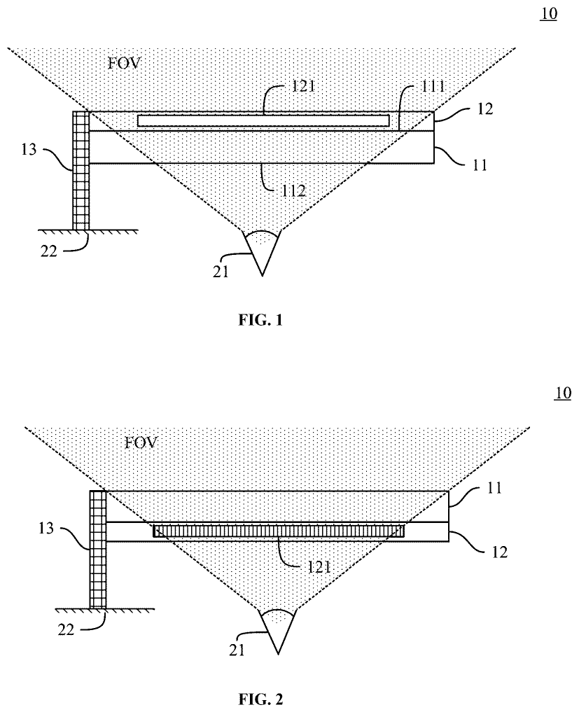

Reference is made to FIG. 1, which is a schematic structural diagram of a lens assembly according to an embodiment of the present disclosure. As shown in FIG. 1, the lens assembly 10 comprises a first lens 11, a first film 12, and a frame 13.

The first lens 11 is configured to provide a FOV of a real world to an eye 21 of a user, and has a first surface 111 and a second surface 112 that are opposite to each other. Herein the real world refers to reality, i.e., the actual world which exists around the user and often comprises real objects. In the field, the “real world” may serve as a relative concept of a “virtual world”, which refers to a computer-simulated world, usually three dimensional (3D) and comprising virtual objects, provided through virtual reality (VR) techniques, such as voxel presentation, point-cloud codec, and point-cloud rendering. Herein the FOV refers an extent of the observable world that is seen by the eye 21 of the user at any given moment. Providing the FOV of the real world refer to that the first lens 11 enables the user to observe a region of the real world through the first lens 11, and the extent of such region is the FOV. Generally, a range of the region is limited or defined by a configuration of the first lens, such as a shape and a focus length of the first lens 11. The FOV may be a solid angle, as indicated by a region between two dashed lines in FIG. 1, through which the eye 21 of the user can recognize one or more objects in the real world. Content within the FOV may be changed based on a movement of the lens frame or a movement of the user. In practice, a specific shape of the FOV may be determined according to optical instruments of the lens assembly 10, such as the first lens 11.

The first lens 11 may be made of various materials, such as glass, plastic, and polymer (also called organic glass). Generally, the first lens 11 is transparent or substantially transparent, and may have a color on requirement (for example, being required to screen visible light of a certain wavelength). The first lens 11 may be translucent when, for example, a blurring visual effect is required. Moreover, the first lens 11 may be rigid or elastic based on an actual requirement. Herein the term “lens” may be interpreted as: i) an optical piece of which one or both of its opposite surfaces, for example, the first surface 111 and the second surface 112 of the first lens 11, have a convex or concave shape, ii) an optical piece which has a non-uniform refractive index and thereby has an optical property similar to that having a convex or concave surface, iii) an optical piece which is placed in front of an eye of a user as a shield and is configured to, for example, protect the eye. Those skilled in the art can appreciate that the lens may be implemented in other feasible forms. Accordingly, each of the first surface 111 and the second surface 112 of the first lens 11 may be configured as a concave surface, a convex surface, a planar surface, or a surface of another shape according to a requirement of the FOV or a visual perception ability of the eye 21.

The first film 12 is disposed on the first surface 111 of the first lens 11, and comprises a first antenna electrode 121. The first antenna electrode 121 is at least partially located within the FOV and serves as at least a part of a first antenna (of which other parts are not depicted) of the wireless electronic device 10. Herein the first film 12 may be disposed directly on the first surface 111, i.e., directly attached to the first surface 111, as shown in FIG. 1. Alternatively, the first film 12 may be attached to the first surface 111 via an intermediate layer, such as an adhesive.

Although the first film 12 covers the whole first surface 111 in a view as shown in FIG. 1, it is appreciated that the first film 12 may cover only a part of the first surface 111. In some embodiments, the first film 12 covers a portion of the first surface 111 at which the first antenna electrode 121 is located. In such case, possible interference of the first film 12 to the sight of the user may be reduced to some extent.

The first antenna electrode 121 may be wholly located within the FOV, as shown in FIG. 1. Alternatively, the first antenna electrode 121 may be merely partially located within the FOV, which reduces possible occlusion to a sight of the user. Moreover, the first antenna electrode 121 may be configured in various shapes, such as a loop, a stripe, an “F” shape, an “L” shape, or a meander shape, which is not limited herein. Generally, the shape of the first antenna electrode 121 depends on a type of the first antenna, which may be a monopole antenna, a dipole antenna, a loop antenna, a slit antenna, etc. In some embodiments, the first antenna electrode 121 or the part thereof located in the FOV adopts a shape conformed to an edge of the FOV. That is, the first antenna electrode 121 is disposed at the edge of the FOV, so as to reduce occlusion to the sight of the user.

In some embodiments, the first surface 111 is configured to be located farther form the eye than the second surface 112 when the first lens 11 provides the FOV. That is, when the user uses the wireless electronic device comprising the lens assembly 10, the first surface 111 at which the first film 12 is located faces outwards (i.e., to the real world), while the second surface 112 faces inward (i.e., to the user). The first surface 111 facing outward renders a distance between the first antenna electrode 121 and the user larger in comparison with a case of the first surface 111 facing inward, which reduces interference of the human body on the wireless signals transmitted/received by the first antenna. Moreover, such configuration also reduces interference of the first lens 11 on the wireless communications. Therefore, the quality of the wireless communication can be improved. It is appreciated that the first surface 111 may alternatively face inward in other embodiments, especially when degradation of the wireless signals is due to the human body and/or the first lens 11 is tolerable in view of environmental risks that may damage the first antenna electrode 121. For example, the wireless electronic device comprising the lens assembly 10 may be used in an environment that having extreme temperature, pressure, or humidity, and the first antenna electrode 121 is desirable to be hidden from the real world by the first lens 11. Reference is made to FIG. 2, which is a schematic structural diagram of a lens assembly according to another embodiment of the present disclosure. On a basis of the structure as shown in FIG. 1, the first lens 11 and the first film 12 are flipped inside-out, that is, the first antenna electrode 121 is disposed between the first lens 11 and the eye 21.

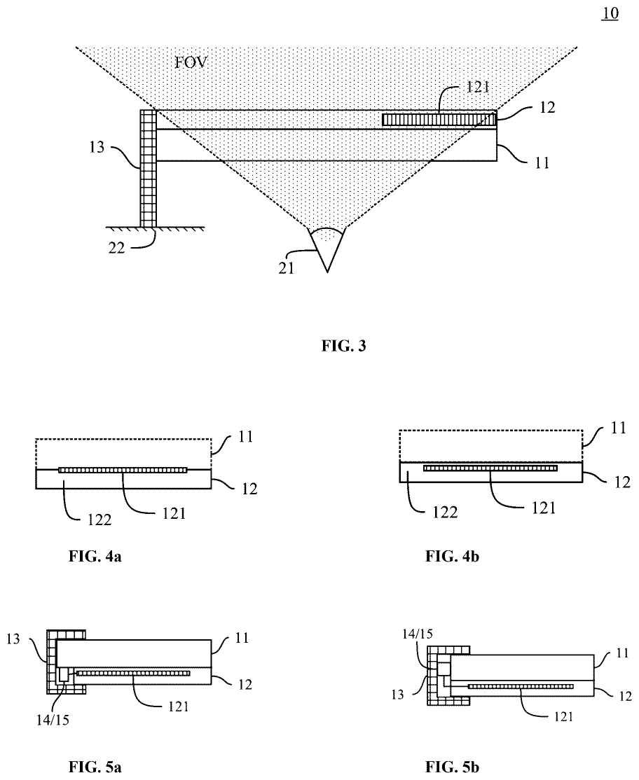

In some embodiment, the first antenna electrode 121 is configured to be located at a portion, which is away from a body of the user among the first film 12 located within the FOV, when the first lens 11 provides the FOV. That is, when the user uses the wireless electronic device comprising the lens assembly 10, the first antenna electrode 121 is disposed away from the human body within the FOV, so as to reduce the interference of the human body on the wireless signals transmitted and/or received by the first antenna. A specific location of such portion of the first film 12 depends on a relative position between the first film 12 and the human body during the usage of the wireless electronic device. For example, the wireless electronic is smart eyeglasses and the lens assembly 10 corresponds to a left lens (i.e., the lens in front of the left eye of the user) of the eyeglasses. In such case, the portion of the first film 12 may be located at a left rim (with respect to the wearer) of the left lens, because the right rim is too close to the nose, the upper rim is too close to the eyebrow, and the bottom rim is too close to the face. Similarly, when the lens assembly corresponds to a right lens of the eyeglasses, the portion may be the right rim of the right lens. Reference is made to FIG. 3, which is a schematic structural diagram of a lens assembly according to another embodiment of the present disclosure. On a basis of the structure as shown in FIG. 1, the first antenna electrode 121 is moved to a side of the first film 12 away from the body (indicated by a skin of a body 22 of a wearer) while still partially located in the FOV. Thereby, the interference of the body on the wireless signal is reduced due to an increased distance between the first antenna electrode 121 and the body. Although the first antenna electrode 121 is depicted as located at rightmost of the first film 12, it is appreciated that in some embodiments there may be a distance between the first antenna electrode 121 and the edge of the first film 12, especially when there is no frame at such edge. It is further appreciated that the first antenna electrode 121 may alternatively be wholly disposed in the FOV when moved to the edge portion.

In some embodiments, the first film 12 comprises a substrate 122 besides the first antenna electrode 121, and the first antenna electrode 121 is a conductive pattern which is embedded in the substrate 122 or disposed on a surface of the substrate 122 facing first lens 11. Reference is made to FIGS. 4a and 4b, which are schematic structural diagrams of a first film according to embodiments of the present disclosure. It is taken as an example that the first film 12 is directly attached to the first lens 11. In FIG. 4a, the first antenna electrode 121 is disposed on the contact surface between the substrate 122 and the first lens 11. Such configuration may be implemented by first bonding the conductive pattern (i.e., the first antenna electrode 121) to either the substrate 122 or the first lens 11 and then bonding the substrate 122 to the first lens 11, or by forming the first antenna electrode 121 and the substrate 122 sequentially on the first surface 111, both of which are simple in manufacture. In FIG. 4b, the first antenna electrode 121 is wrapped by the substrate 122. Such configuration reduces a possibility of detachment or deformation between the first film 12 and the first lens 11, which improves robust of the lens assembly. Cases in which the first film 12 is indirectly attached to the first lens 11 can be deduced by analogy from the examples as shown in FIGS. 4a and 4b. Moreover, besides the structures as shown in FIGS. 4a and 4b, the conductive pattern may alternatively be disposed on a surface of the substrate 122 away from the first lens 11 (which is not depicted). In such case, there may be another layer covering the surface of the substrate 122 away from the first lens 11 to protect the first antenna electrode 121.

Herein the substrate 122 may serve as a protective coating on the first lens 11, which protects both the first surface 111 and the first antennal electrode 121. The first antenna electrode 121 is made of a conductive material such as metal, and the substrate 122 is made of a nonconductive material such as polymer. Similar to the first lens 11, the first film 12 may be either rigid or elastic. In a case that the first lens 11 is elastic, the first film 12 is preferably to be elastic to facilitate deformation of the first lens.

The first antenna may be formed by the first antennal electrode solely, or may comprise another component such as an additional antenna electrode. In the latter case, the additional antenna electrode may or may not be a part of the first film 12, and may or may not be a part of the lens assembly 10. For example, the other component may be an external component, and the lens assembly 10 may provide an interface for connecting the external component to the first antennal electrode 121 when using the first antenna for wireless communications.

The frame 13 is configured to support the first lens 11 at a body 22 of the user. Herein the body 22 may comprise a body part which contacts the frame 13 directly or provides a support for the frame 13 indirectly, for example, via housing of the wireless electronic device. As an example, the body part may be a nose or ears when the wireless electronic device is a smart eyeglasses or a smart monocle, may be a hand when the wireless electronic device is smart binoculars or a smart monocular, or may be a head when the wireless electronic device is a smart mask or a smart helmet. The frame 13 may serve as a part of the housing, or may be independent from the housing. In the latter case, the frame 13 may be mounted on the housing or accommodated by the housing. The present disclosure is not limited thereto. It is taken as an example that smart glasses serve as wireless electronic device, and a right lens thereof is the lens assembly. In such case, the frame 13 may comprise the right lens frame surrounding the right lens, and the housing may comprise the left lens frame, the nose pads, the temple bars and the bridge. Optionally, the right lens frame may also serve as a part of the housing.

Although the frame 13 is merely depicted at left of the first lens 11 and the first film 12 in FIG. 1, the present disclosure is not limited thereto. In practice, the frame 13 may be in physical contact with the first lens 11 and/or the first film 12 at any portion as long as it does not cause severe occlusion in the sight of the user. For example, the frame 13 may surround the whole edge of the first lens 11, or the frame 13 may be only fixed to the lens 11 at a point on the edge. It is appreciated that the frame 13 may participate in defining a region of the FOV together with the first lens 11.

In some embodiments, a whole of the frame 13 is made of a conductive material. For example, the frame 13 is a full-metallic frame. Since the conductive frame would induce electromagnetic shielding on the wireless signals, it would be hazardous to dispose the first antenna electrode 121 within the frame. Generally, a “window” made of non-conductive material should be provided among the conductive frame as an entry and/or an exit of the wireless signals, or the antenna is exposed among the conductive frame. The former scheme requires splicing the conductive material and the non-conductive material in the frame 13, and the latter scheme requires breaking and windowing the conductive material, both of which result in a complicated manufacture process and reduce robustness of the frame 13. In comparison, disposing the first antenna electrode 121 on the first lens 11 is much more beneficial, because the integrity of the conductive frame can be maintained. Moreover, there would be little electromagnetic shielding since the FOV of the real world is occluded by the conductive frame. That is, both the robustness of the lens assembly and the quality of the wireless communications can be ensured.

The above benefits can also be achieved besides the case of the fully conductive frame 13. In some embodiments, the frame 13 comprises a first part made of a conductive material and a second part made of a non-conductive material, and an area of the second part is smaller than an area of the first antenna electrode 121. That is, it is also impossible to dispose the first antenna electrode 121 in the frame 13 without breaking the integrity of the conductive part and introducing large interference on the wireless signals. Hence, disposal of the first antenna electrode 121 on the first lens 11 is also much beneficial than the other schemes. Moreover, the benefits also apply to other cases in which the first antenna electrode 121 is not suitable to be disposed at the frame 13, for example, when a space within the non-conductive housing is not capable to accommodate the first antenna electrode 121.

In some embodiments, the lens assembly 10 may further comprises an RF circuitry (not depicted) which is electrically connected to the first antenna electrode 121. Generally, the RF circuitry is electrically connected to a feed point of the first antenna, for example, of the first antenna electrode. Herein the RF circuitry may be coupled with or may be a part of processing circuitry, and is configured to convert the oscillating current or the oscillating voltage into a signal compatible with a processing capability of the processing circuitry, or the vice versa. Generally, the conversion is implemented through modulation or demodulation. Specifically, the RF circuitry modulates the oscillating current or the oscillating voltage based on a signal generated by the processing circuitry, and then the first antenna converts the modulated oscillating current or the oscillating voltage into the wireless signals. Similarly, the first antenna coverts the received wireless signals into the oscillating current or the oscillating voltage, and the RF circuitry demodulates the oscillating current or the oscillating voltage to acquire a signal for processing at the processing circuitry. The processing at the processing circuitry may include, but is not limited to, coding or decoding of visual signals, acoustic signals, or control signals. In practice, the processing circuitry may be implemented in various manners. For example, the processing circuitry may be an application specific integrated circuit (ASIC), a field-programmable gate array (FPGA), a special-purpose chip, or the like. For another example, the processing circuitry is an independent chip mounted on a printed circuit board (PCB), or may be integrated into another chip having multiple functions. The present disclosure is not limited to the above example, and any appropriate chip may serve as the processing circuitry as long as it is capable to process the wireless signals.

The RF circuitry may be directly coupled to the first antenna electrode 121. Alternatively, in some embodiments, the lens assembly 10 further comprises one or both of a communication cable 14 and an impedance matcher 15. The communication cable 14 is electrically connected between the RF circuitry and the first antenna electrode 121. In an embodiment, the communication cable 14 is electrically connected to the first antenna electrode 121 at the foregoing feeding point, so as to provide a feed to the first antenna. The communication cable may be insulated by a non-conductive coating or a non-conductive skin. In an embodiment, the communication cable may be a coaxial cable. The impedance matcher 15 is electrically connected between the RF circuitry and the first antenna electrode 121, and is configured to suppress impedance mismatch between the first antenna and the RF circuitry. Generally, the impedance matcher adjusts antenna impedance to approximately 50 ohm on the smith-chart. In a case that there is the communication cable 14, the impedance matcher 15 may be provided between the communication cable 14 and the first antenna electrode 121. In an embodiment, the impedance matcher 15 is electrically connected to the first antenna electrode 121 at the foregoing feeding point, so as to provide a feed to the first antenna. The impedance matcher 14 may be a matching circuit comprising one or more inductors and/or one or more capacitors. The matching circuit may be a flexible printed circuit (FPC) or may be formed by laser direct structuring (LDS).

Herein the one or both of the communication cable 14 and the impedance matcher may be covered by the frame 13. That is, the communication cable 14 and/or the impedance matcher 15 may be embedded in or accommodated by the frame 13, and thereby is protected by the frame 13 and does not introduce occlusion in the FOV. In practice, the communication cable 14 and/or the impedance matcher 15 may be disposed in any position of the frame 13, as long as the electrical connection between the RF circuitry and the first antenna electrode 121. In some embodiments, the communication cable 14 and/or the impedance matcher 15 are disposed at an edge of the first lens. Reference is made to FIG. 5a and FIG. 5b, which are schematic structural diagrams of a lens assembly according to other embodiments of the present disclosure. In an embodiment as shown in FIG. 5a, the communication cable 14 and/or the impedance matcher 15 are at least partially located at an edge portion of the first surface 111 (or of the second surface, which is not depicted). In an embodiment as shown in FIG. 5b, the communication cable 14 and/or the impedance matcher 15 are at least partially located at an edge surface connecting the first surface 111 and the second surface 112. Configurations of the frame 13 as shown in FIGS. 5a and 5b are merely illustrative, and the present disclosure is not limited thereto. For example, the cross section of the frame may be L-shaped instead of the C-shaped, or the communication cable 14 and/or the impedance matcher 15 may be embedded into the frame 13 rather than located in a cavity defined by the frame 13, the first lens 11, and the first frame 12. Moreover, although the electrical connection between the first antenna electrode 121 and the communication cable 14 and/or the impedance matcher 15 is depicted as a line in FIGS. 5a and 5b, their actual connection point may be located in the first film 12 (i.e., a part of the communication cable 14 and/or the impedance matcher 15 extends into the first film 12), outside the first film 12 (i.e., a part of the first antenna electrode 121 extends out of the first film 12), or just at an edge of the first film 12. In some embodiment, the connection point may even be implemented in the first lens 11.

Since the first antenna electrode 121 is at least partially located within the FOV, it is desirable that the first antenna electrode 121 introduces occlusion as little as possible, so as to ensure a clear sight of the user. In some embodiments, the first film 12 is transparent or substantially transparent, so as to achieve the above objective. In such case, the first film 12 being transparent means that both the first antenna electrode 121 and the substrate 122 are transparent. In practice, the first antenna electrode 121 may be made of a transparent alloy, such as indium tin oxide (ITO), or a transparent metal film, and the substrate 122 may be a transparent polymer, such as polyethylene terephthalate (PET), or a transparent inorganic layer such as silicon dioxide. In other embodiments, the first film 12 is translucent, i.e., one or both of the first antenna electrode 121 and the substrate 122 is translucent, which may sacrifice a visual effect to some extent and enrich candidate material for manufacturing the first film 12. Similar to the first lens 11, the first film 12 may be colored on requirement. Additionally or alternatively, in some embodiments, the frame 13 may be configured to keep the first antenna electrode 121 within a range between the eye 21 and a near point of the eye 21. The near point refers to a point nearest the eye at which an object is accurately focused on the retina at full accommodation. Generally, the eye 21 does not focus on a position closer than the near point, and hence the first antenna electrode is hard to be perceived. Hence, even if the first film 12 is not transparent, it is not perceivable when a dimension is small enough. The smaller the dimension is, the larger a distance between the first antenna electrode 121 and the eye 21 is permitted to be. Therefore, the occlusion in the sight of the user can also be reduced. In some embodiments, one of the transparency, a distance to the eye 21, and a dimension of the first antenna electrode 121 may be determined based on the other two, in order to render the first antenna electrode 121 negligible to user's vision.

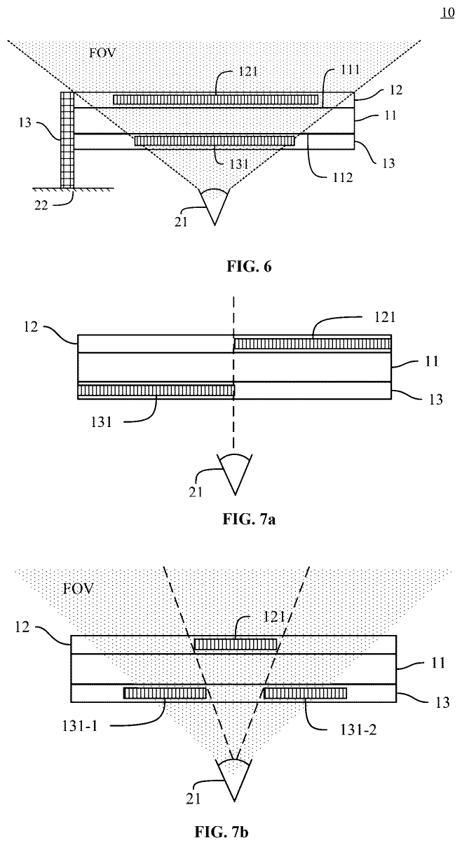

Besides the first antenna electrode 121, the lens assembly 10 may further comprise one or more other antenna electrodes. Reference is made to FIG. 6, which is a schematic structural diagram of a lens assembly according to another embodiment of the present disclosure. In some embodiments, the lens assembly 10 further comprises a second film 13 located on the second surface 112, the second film 13 comprises a second antenna electrode 131, and the second antenna electrode 131 is at least partially located within the FOV.

Similar to the first film 12, the second film 13 may be disposed directly on the second surface 112, or attached indirectly via an intermediate layer to the second surface 112. The second film 13 may cover a whole of the second surface 112 or cover only a part of the second surface 112. The second film may comprises a substrate besides the second antenna electrode 131, and the second antenna electrode 131 is a conductive pattern which is embedded in the substrate, disposed on a surface of the substrate facing first lens 11, or disposed on a surface of the substrate away from the first lens 11 (with or without a cover layer). Other details of the second film 13 may refer to those of the first film 12 as illustrated in the forgoing description, and are not repeated herein. It is appreciated that the second film 13 may be identical to or different from the first film 12 in materials and/or shapes according to an actual requirement.

Similar to the first antenna electrode 121, the second antenna electrode 131 may be wholly or partially located within the FOV, and may adopt a shape conformed to an edge of the FOV. The second antenna electrode 131 may be located at a portion, which is away from a body of the user among the second film 13 located within the FOV, when the first lens 11 provides the FOV, and a specific location of such portion of the second film 13 depends on a relative position between the second film 13 and the human body during the usage of the wireless electronic device. Other details of the second antenna electrode 131 may refer to those of the first antenna electrode 121 as illustrated in the forgoing description, and are not repeated herein. It is appreciated that the second antenna electrode 131 may be identical to or different from the first antennal electrode 121 in materials and/or shapes according to an actual requirement.

In some embodiments, the second antenna electrode 131 serves as another part of the first antenna. That is, the first antenna electrode 121 and the second antenna electrode 131 together may form the first antenna, and coordinate when transmitting or receiving the wireless signals. A shape of the second antenna electrode 131 may also depend on the type of the first antenna. Herein the two antenna electrodes may be electrically connected at an edge of the first lens 11 (not depicted), or may be electrically connected via a through hole or a through slit running through the first lens 11 (not depicted). In an embodiment, the feeding point of the first antenna may be the connection point between the first antenna electrode 121 and the second antenna electrode 131. That is, in a case that the lens assembly 10 comprises the foregoing RF circuitry, the forgoing communication cable 14, and/or the forgoing impedance matcher 15, one of these components is electrically connected to both the two antenna electrodes at the connection point, which may be covered by the frame 13. It is appreciated that the first antenna may further comprise another component besides the first antenna electrode 121 and the second antenna electrode 131.

In other embodiments, the second antenna electrode 131 serves as at least a part of a second antenna. That is, the first antenna electrode 121 and the second antenna electrode 131 are of different antennas. Similar to the first antenna, the second antenna may be of various types, and a shape of the second antenna electrode 131 may depend on the type of the second antenna. Herein the first antenna and the second antenna may be configured to transmit wireless signals in different frequency bands and/or under different wireless communication protocols, so as to expand a communication adaptability of the lens assembly 10. For example, the two antennas may be configured for communications under any two protocols, respectively, among 2.4 GHz Wi-Fi, 5 GHz Wi-Fi, Bluetooth™, Zigbee, various 3rd Generation Partnership Project (3GPP) protocols, and the like. Alternatively, the first antenna and the second antenna may be configured to transmit wireless signals in the same frequency band and/or the same communication protocol. In such case, the first antenna electrode 121 and the second antenna electrode 131 may be aligned in different directions to expand a wireless coverage of the lens assembly 10. Additionally or alternatively, the second antenna may serve as a backup for malfunction of the first antenna. The two antennas may share the same RF circuitry, and signals between the RF circuitry and the two antennas may be routed via filtering circuitry and switching circuitry, which is not limited herein.

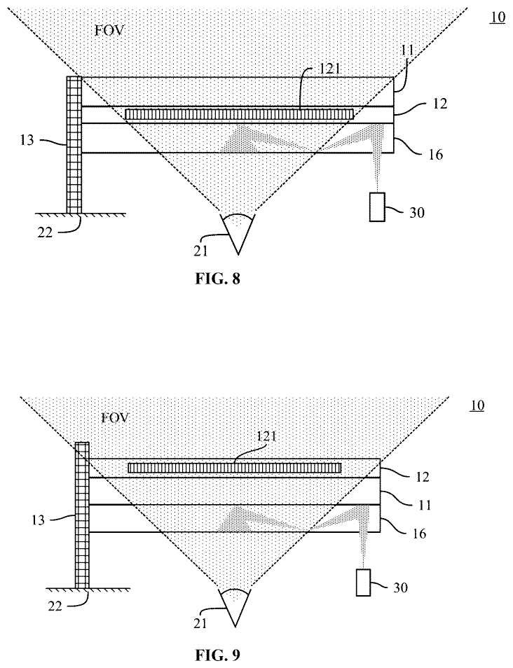

In some embodiments, the first antenna electrode 121 and the second antenna electrode 131 do not overlap in a direction of the eye 21 perceiving the FOV. Reference is made to FIG. 7a, which is a schematic structural diagram showing positional relationship between antenna electrodes of a lens assembly according to an embodiment of the present disclosure. As shown in FIG. 7a, the direction of the eye 21 perceiving the FOV (i.e., a line of sight) is indicated by a dash line, which points upward, and the first antenna electrode 121 and the second antenna electrode 131 are disposed at right and left, respectively, of the first lens along such direction. The non-overlapping arrangement of the two antenna electrodes reduces occlusion to the sight of the user, especially when the two antenna electrodes are not thoroughly transparent. It is noted that the two antenna electrodes not overlapping in the eye-perception direction does not mean that they do not overlap along a thickness direction of the first lens 11. Reference is made to FIG. 7b, which is a schematic structural diagram showing positional relationship between antenna electrodes of a lens assembly according to another embodiment of the present disclosure. As shown in FIG. 7b, the second antenna 131 is depicted as two parts 131-1 and 131-2, which may represent two different pieces or a same piece (i.e., merely separated in the cross sectional view) of the second antenna electrode 131. Along the thickness direction of the lens 11, the first antenna electrode 121 is located between the two parts 131-1 and 131-2, and overlaps with each of the two parts. When the eye 21 perceives the FOV, neither the part 131-1 nor the part 131-2 overlaps with the fist antenna electrode 121, as indicated by the two dash lines representing lines of sight of the eye 21. Hence, such arrangement can still be treated as non-overlapping in a sense of the eye-perception. It is appreciated that besides alleviating occlusion in the FOV, the non-overlapping arrangement can also reduce interference between the first antenna electrode 121 and the second antenna electrode 131, mainly due to their spatial separation.

It is further appreciated that although the second film 13 is depicted to be located between the first film 12 and eye 21 in FIGS. 6, 7a, and 7b, such structure may be flipped upside down to achieve a structure in which the first film 12 is located between the second film 13 and the eye 21. That is, the second film 13 may be provided on the second surface 112 when the second surface 112 faces outward and the first surface 111 faces inward. Details of such implementation may refer to the foregoing embodiments by exchanging the first film 12 and the second film 13 and exchanging the first antenna electrode 121 and the second antenna electrode 131, and are not repeated herein.

The lens assembly 10 may further have a function of display. That is, visual information is displayed in the FOV and overlaps with the real world perceived by the eye 21. Generally, such technique belongs to the technical filed of augmented reality (AR) or mixed reality (MR). In the AR, messages and prompts may be displayed on the lens assembly 10 at a portion of the FOV. In the MR, virtual objects may be displayed on the lens assembly 10 within the FOV and introduce some interactive operations with the real objects perceived in the FOV. In order to achieve the display function, an additional optical component may be introduced into the lens assembly. Reference is made to FIG. 8, which is a schematic structural diagram of a lens assembly according to another embodiment of the present disclosure. On a basis of the structure as shown in FIG. 2, the lens assembly 10 as shown in FIG. 8 further comprises a waveguide 16. The waveguide 16 is attached to the first lens 11 and at least partially disposed within the FOV. The waveguide 16 is configured to receive a light signal projected on a part of the waveguide 16, so as to form an image perceivable to the eye 21 of the user.

Herein the waveguide 16 may be an optical layer or an optical sheet on which one or more set of optical gratings are provided. As an example, a first region of the waveguide 16 has first optical gratings configured to receive the light signal, and a second region of the waveguide 16 has second optical gratings configured to output the image. For example, as shown in FIG. 8, an image source 30 emits the light signal (as indicated by shaded triangles in FIG. 8), such as one or more chromatic light beams modulated to contain information of the image, to the first optical gratings. In such case, the light signal is coupled into the waveguide 16 via the first optical gratings, then is totally reflected within the waveguide until being outputted from the waveguide 16 via the second optical gratings, and perceived by the eye 21 of the user as the image. The gratings may be implemented as micro-grooves or micro-ridges on a surface of the waveguide 16. In addition, the introduction and extraction of the light signal may be implemented through optics other than the gratings, such as reflective holographic optics or a reflective film. In practice, the waveguide 16 may comprise multiple layers, each of which is configured to receive a corresponding chromatic light beam and output a chromatic image, and the final image is displayed by overlapping the chromatic images of the multiple layers. For example, there may be three layers for red, green, blue light beams, respectively.

Herein the image source 30 may be a part of the lens assembly 10, or may be a component independent from the lens assembly. In the latter case, the image source 30 may be a part of the wireless electronic device comprising the lens assembly. The present disclosure not limited thereto.

As shown in FIG. 8, in some embodiments, the first film 12 is located between the waveguide 16 and the first lens 11. In such case, the first film 12 may serve as a bonding layer between the first lens 11 and the waveguide 16, and/or may serve as a buffer layer between the first lens 11 and the waveguide 16, especially when both the first lens and the waveguide 16 are made of rigid materials. Moreover, the first antenna electrode 121 sandwiched between the first lens 11 and the waveguide 16 are protected at both sides. As an alternative, in some embodiments, the first film 12 may be located at a side of the first lens 11 away from the waveguide 16. Reference is made to FIG. 9, which is a schematic structural diagram of a lens assembly according to another embodiment of the present disclosure. The structure as shown in FIG. 9 is similar to that as shown in FIG. 1 except for the waveguide 16. The waveguide 16 may be directly attached to the first lens 11, or may be attached to the first lens 11 via an intermediate layer (not depicted) such as an adhesive or a buffer layer. In such structure, the first antenna electrode 121 is closer to the ambient space in the real world and farther from the body 22, and hence may achieve better quality of the wireless signals due to less inference from the human body.

Although the structures in both FIGS. 7 and 8 are depicted based on a sequence of the waveguide 16 being located between the first lens 11 and the eye 21, these structures may be flipped in other embodiments, that is, the waveguide 16 may be configured to be located at a side of the first lens 11 away from the eye 21 during usage. The present disclosure is not limited to any specific sequence.

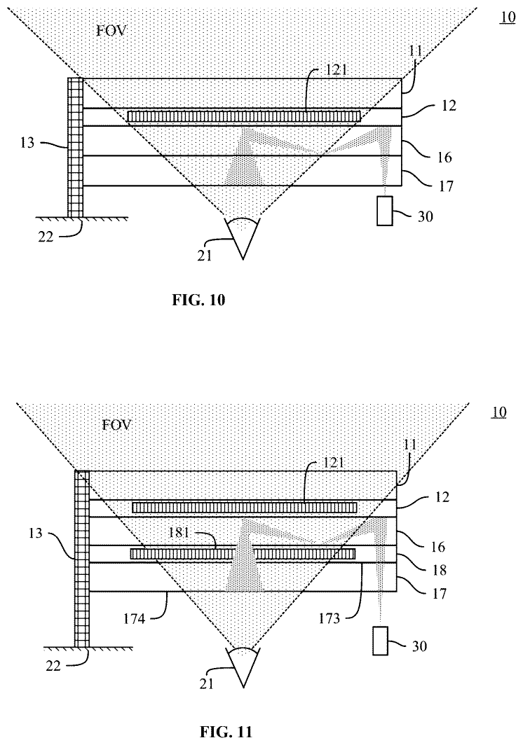

As discussed above, the waveguide 16 comprises fine structures for inputting, transmitting, and outputting the light signal, and hence it may be desirable to provide some protection on the waveguide 16. In some embodiments, besides the first lens 11, another lens is provided at the other side of the waveguide 16. Reference is made to FIG. 10, which is another schematic diagram of a lens assembly according to another embodiment of the present disclosure. On a basis of the structure as shown in FIG. 8, the lens assembly 10 may further comprise a second lens 17 which is attached to the waveguide 16, the second lens 17 is at least partially located within the FOV, and the waveguide 16 between the first lens 11 and the second lens 17.

Similar to the first lens 11, the second lens 17 may be made of various materials such as glass, plastic, or polymer. The second lens 17 may be transparent, substantially transparent, or translucent, and may have a color on requirement. The second lens 11 may be rigid or elastic. Other details of the second lens 17 may refer to those of the first lens 11 as illustrated in the forgoing description, and are not repeated herein. It is appreciated that the second lens 17 may be identical to or different from the first lens 11 in materials and/or shapes according to an actual requirement.

In some embodiments, the first lens 11 is located farther from the eye 21 than the second lens 17, when the first lens 11 provides the FOV, as shown in FIG. 10. That is, when the user uses the wireless electronic device comprising the lens assembly 10, the first lens 11 at which the first film 12 is located is disposed at an outer side (i.e., closer to the real world) of waveguide 16, while the second surface 112 is disposed at an inner side (i.e., closer to the user) of the waveguide 16. A distance between the first antenna electrode 121 and the user is larger in comparison with a case of the first lens is located at the inner side while the second lens 17 is located at the outer side, which reduces interference of the human body on the wireless signals transmitted/received by the first antenna. Moreover, such configuration also reduces interference of the waveguide 16 on the wireless communications. Therefore, the quality of the wireless communication can be improved. It is appreciated that the first lens 111 may alternatively be disposed at the inner side in some embodiments, especially when degradation of the wireless signals is due to the human body and/or the waveguide 16 is tolerable in view of environmental risks that may damage the first antenna electrode 121. For example, the wireless electronic device comprising the lens assembly 10 may be used in an environment that having extreme temperature, pressure, or humidity, and the first antenna electrode 121 is desirable to be hidden from the real world by the first lens 11. That is, a specific sequence between the first lens 11 and the second lens 17 are not limited herein, and may be determined based on an actual requirement.

Similar to the first lens 11, the second lens 17 may be provided with another antenna electrode. Reference is made to FIG. 11, which is a schematic structural diagram of a lens assembly according to another embodiment of the present disclosure. In some embodiments, the second lens has a third surface 173 and a fourth surface 174. The lens assembly 10 further comprises a third film 18 located on the third surface 173, the third film 18 comprises a third antenna electrode 181, and the third antenna electrode is at least partially located within the FOV.

Similar to the first film 12, the third film 18 may be disposed directly on the third surface 173, or attached indirectly via an intermediate layer to the third surface 174. The third film 18 may cover a whole of the third surface 174 or cover only a part of the third surface 174. The third film 18 may comprises a substrate besides the third antenna electrode 181, and the third antenna electrode 181 is a conductive pattern which is embedded in the substrate, disposed on a surface of the substrate facing second lens 17, or disposed on a surface of the substrate away from the second lens 17 (with or without a cover layer). Other details of the third film 18 may refer to those of the first film 12 as illustrated in the forgoing description, and are not repeated herein. It is appreciated that the third film 18 may be identical to or different from the first film 12 in materials and/or shapes according to an actual requirement.

Similar to the first antenna electrode 121, the third antenna electrode 181 may be wholly or partially located within the FOV, and may adopt a shape conformed to an edge of the FOV. The third antenna electrode 181 may be located at a portion, which is away from a body of the user among the third film 18 located within the FOV, when the first lens 11 provides the FOV, and a specific location of such portion of the third film 18 depends on a relative position between the third film 18 and the human body during the usage of the wireless electronic device. Other details of the third antenna electrode 181 may refer to those of the first antenna electrode 121 as illustrated in the forgoing description, and are not repeated herein. It is appreciated that the third antenna electrode 181 may be identical to or different from the first antennal electrode 121 in materials and/or shapes according to an actual requirement.

It is appreciate the third antenna electrode 181 can achieve technical advantages similar to those achieved by the first antenna electrode 121. Although the third surface of 173 of the second lens 17 is depicted as a surface facing the waveguide 16, it is appreciate it may alternatively be a surface facing away from the waveguide 16. Details of such configuration may refer to the foregoing description concerning FIG. 9, which is not repeated herein.

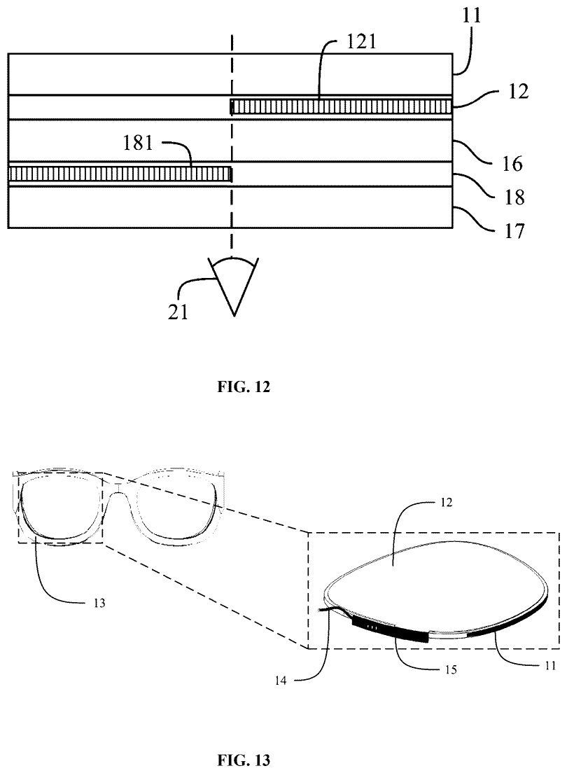

In some embodiments, the first antenna electrode 121 and third antenna electrode 181 do not overlap in a direction of the eye 21 perceiving the FOV. Reference is made to FIG. 12, which is a schematic structural diagram showing positional relationship between antenna electrodes of a lens assembly according to another embodiment of the present disclosure. As shown in FIG. 12, the direction of the eye 21 perceiving the FOV (i.e., a line of sight) is indicated by a dash line, which points upward, and the first antenna electrode 121 and the second antenna electrode 131 are disposed at right and left, respectively, of the first lens along such direction. The non-overlapping arrangement of the two antenna electrodes reduces occlusion to the sight of the user, especially when the two antenna electrodes are not thoroughly transparent. Other details of such configuration may refer to the foregoing description concerning FIGS. 7a and 7b, and are not repeated herein.

In some embodiments, the third antenna electrode 181 serves as another part of the first antenna. That is, the first antenna electrode 121 and the third antenna electrode 181 together may form the first antenna, and coordinate when transmitting or receiving the wireless signals. A shape of the third antenna electrode 181 may also depend on the type of the first antenna. Herein the two antenna electrodes may be electrically connected at an edge of the first lens 11 and the second lens 17 (not depicted), or may be electrically connected via a through hole or a through slit running through the first lens 11, the waveguide 16, and/or the second lens 17 (not depicted). In an embodiment, the feeding point of the first antenna may be the connection point between the first antenna electrode 121 and third antenna electrode 181. Details of such configuration may refer to those of the foregoing configuration in which the first antenna electrode 121 and the second antenna electrode 131 together may form the first antenna, and are not repeated herein.

In alternative embodiments, the third antenna electrode 181 serves as at least a part of a third antenna. That is, the first antenna electrode 121 and third antenna electrode 181 are of different antennas. Similar to the first antenna, the third antenna may be of various types, and a shape of the third antenna electrode 181 may depend on the type of the third antenna. The first antenna and the second antenna may be configured to transmit wireless signals in different frequency bands and/or under different wireless communication protocols, or transmit wireless signals in the same frequency band and/or the same communication protocol. Details of such configuration may refer to those of the foregoing configuration in which the first antenna electrode 121 and the second antenna electrode 131 are of different antennas, and are not repeated herein.

In other embodiments, the lens assembly 10 comprises all of the foregoing antenna electrodes, that is, the first antenna electrode 121, the second antenna electrode 131, and the third antenna electrode 181. In such case, the third antenna electrode 181 may serve as another part of the second antenna. That is, the second antenna electrode 131 and the third antenna electrode 181 together may form the second antenna, and coordinate when transmitting or receiving the wireless signals. Still, the first antenna and the second antenna may be configured to transmit wireless signals in different frequency bands and/or under different wireless communication protocols, or transmit wireless signals in the same frequency band and/or the same communication protocol. Alternatively, the three antennal electrodes may be electrically connected, and form at least a part of the first antenna. Details of these configurations may refer to those of the foregoing configurations, and are not repeated herein.

Moreover, similar to the first lens 11 having both the first film 12 and the second film 13, a fourth film may be further provided at the fourth surface 114 of the second lens 17 and comprise a fourth antenna electrode at least partially located in the FOV. Details of the fourth film and the fourth antenna electrode may refer to those of the second film 13 and the second antenna electrode 131, and are not repeated herein. The fourth antenna electrode may serve as a part of a fourth antenna, or may be electrically connected to another antenna electrode and serve as a part of the corresponding antenna. Details of the above configuration may refer to the foregoing description concerning the other antenna electrodes, and are not repeated herein. Distributing one antenna among different films would reduce a size of the antenna electrode in each layer, and hence reduce possible occlusion of the antenna(s) to the FOV. Moreover, in a case that the lens assembly has multiple of the forgoing films having the antenna electrodes, the antenna electrodes may overlap with each other in a direction of the eye 21 perceiving the FOV.

Hereinabove the lens assembly is illustrated according to embodiments of the present disclosure. In another aspect, a wireless electronic device is further provided according to embodiments of the present disclosure. The wireless electronic device comprises at least one lens assembly, each of which is the foregoing lens assembly.

Herein the wireless electronic device may be of various forms. As an example, the wireless electronic device is smart eyeglasses, and comprises two lens assemblies corresponding to the left lens and the right lens of the smart eyeglasses. As another example, the wireless electronic device is a smart monocle, and comprises one lens assembly. As another example, the wireless electronic device is a monocle, binoculars, or a microscope, and the objective lens and/or the ocular lens is a lens assembly. Moreover, the wireless electronic device may be a smart helmet, and a visor of the smart helmet is a lens assembly.

In some embodiments, the wireless electronic device further comprising conductive housing configure to fix or accommodate the at least one lens assembly. A whole of the housing may be made of a conductive material.

In some embodiments, two lens assemblies share the RF circuitry, and the RF circuitry is located between the two lens assemblies. For example, the two lens assemblies correspond to the left lens and the right lens of the smart eyeglasses, and the RF circuitry is located at the bridge of the smart eyeglasses.

In some embodiments, the first antenna of one of the at least one lens assembly and the first antenna of another of the at least one lens assembly are configured to transmit or receive wireless signals of different frequency bands. For example, the first antenna of the left lens of the smart eyeglasses is configured for wireless communications under 2.4 GHz Wi-Fi or Bluetooth™, while the first antenna of the right lens of the smart eyeglasses is configured for communications under 5 GHz Wi-Fi. Alternatively, the first antennas of different lens assemblies may be configured transmit or receive wireless signals of the same frequency band. In such case, the wireless communication can have a better coverage, and/or one lens assembly may serve as a backup of the other lens assembly in wireless communication.

Hereinafter smart eyeglasses are illustrated as an example of the wireless electronic device. Reference is made to FIG. 13, which is a schematic diagram of a part of a lens assembly in smart eyeglasses according to another embodiment of the present disclosure. As show in FIG. 13, the right lens of the smart eyeglasses is the foregoing lens assembly, in which the first film 12 comprising the first antenna electrode (not depicted) is attached to the first surface of the first lens 11. The impedance matcher 15 electrically connected to the first antenna electrode and the communication cable 14 electrically connected to the impedance matcher 15 are disposed at an edge surface of the first lens 11. The communication cable 14 and the impedance matcher 15 are covered by a right rim of the right lens frame in the lens assembly, and are connected to the RF circuitry (not depicted) located in the right temple bar (not depicted) of the smart eyeglasses. The right temple bar and the right lens frame may both parts of the frame 13. Alternatively, the right temple bar may be independent from the frame 13 and serve as a part of housing of the smart eyeglasses. The frame 13 and/or the housing may be made of metal. Moreover, the left lens of the smart eyeglasses may be another lens assembly, and may have the same (symmetrical) structure as the right lens.

The embodiments of the present disclosure are described in a progressive manner, and each embodiment places emphasis on the difference from other embodiments. Therefore, one embodiment can refer to other embodiments for the same or similar parts. Since the wireless electronic device disclosed in the embodiments corresponds to the lens assembly disclosed in the embodiments, the description of the device embodiments is simple, and reference may be made to the relevant part of the lens assembly embodiments.

The signal flows and block diagrams in the Figures illustrate the architecture, functionality, and operation of possible implementations of systems, methods, and computer readable media according to various embodiments. In this regard, each block in the block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. It will also be noted that each block of the block diagrams, and combinations of blocks in the block diagrams, can be implemented by special purpose hardware-based systems that perform the specified functions or acts or carry out combinations of special purpose hardware and computer instructions.

No element, act, or instruction used herein should be construed as critical or essential unless explicitly described as such. Also, as used herein, the articles “a” and “an” are intended to include one or more items, and may be used interchangeably with “one or more”. Furthermore, as used herein, the term “set” is intended to include one or more items (e.g., related items, unrelated items, a combination of related and unrelated items, etc.), and may be used interchangeably with “one or more”. Where only one item is intended, the term “one” or similar language is used. Also, as used herein, the terms “has”, “have”, “having”, or the like are intended to be open-ended terms. Further, the phrase “based on” is intended to mean “based, at least in part, on” unless explicitly stated otherwise.

The aforementioned embodiments are only intended to describe the technical solutions of the present disclosure, and not to limit the present disclosure. Although the present disclosure is described in detail with reference to the above embodiments, those skilled in the art should understand that, modifications can be made to the technical solutions recorded in the above embodiments, or equivalent replacements can be made to some of the technical features thereof, and the modifications and the replacements will not make the corresponding technical solutions deviate from the spirit and the scope of the technical solutions of the embodiments of the present disclosure.

1. A lens assembly of a wireless electronic device, comprising:
a first lens, configured to provide a field of view (FOV) of a real world to an eye of a user, wherein the first lens has a first surface and a second surface that are opposite to each other;
a first film disposed on the first surface, wherein the first film comprises a first antenna electrode, and the first antenna electrode is at least partially located within the FOV and serves at least a part of a first antenna of the wireless electronic device; and
a frame, configured to support the first lens at a body of the user.

2. The lens assembly according to claim 1, wherein the first film is transparent or translucent.

3. (canceled)

4. The lens assembly according to claim 1, wherein the first antenna electrode is configured to be located at a portion, which is away from the body among the first film located within the FOV, when the first lens provides the FOV.

5. The lens assembly according to claim 1, wherein the first surface is configured to be located farther from the eye than the second surface when the first lens provides the FOV.

6. The lens assembly according to claim 1, wherein the first film further comprises a substrate, and the first antenna electrode is a conductive pattern which is embedded in the substrate or disposed on a surface of the substrate facing first lens.

7. (canceled)

8. The lens assembly according to claim 1, further comprising:
RF circuitry, electrically connected to the first antenna electrode, and one or both of:
a communication cable, electrically connected between the RF circuitry and the first antenna electrode; and
an impedance matcher, electrically connected between the RF circuitry and the first antenna electrode, wherein the impedance matcher is configured to suppress impedance mismatch between the first antenna and the RF circuitry;
wherein the one of both of the communication cable and the impedance matcher is covered by the frame.

9. The lens assembly according to claim 8, wherein the one of both of the communication cable and the impedance matcher are at least partially located at:
an edge surface connecting the first surface and the second surface, or an edge portion of the first surface or the second surface.

10. The lens assembly according to claim 1, further comprising:
a second film located on the second surface, wherein the second film comprises a second antenna electrode, and the second antenna electrode is at least partially located within the FOV.

11. The lens assembly according to claim 10, wherein the second antenna electrode serves as another part of the first antenna, or at least a part of a second antenna.

12. The lens assembly according to claim 10, wherein the first antenna electrode and the second antenna electrode do not overlap in a direction of the eye perceiving the FOV.

13. The lens assembly according to claim 1, further comprising a waveguide, wherein:
the waveguide is attached to the first lens and at least partially disposed within the FOV, and the waveguide is configured to receive a light signal projected on a part of the waveguide to form an image perceivable to the eye.

14. The lens assembly according to claim 13, wherein the first film is located between the waveguide and the first lens.

15. The lens assembly according to claim 13, further comprising a second lens attached to the waveguide, wherein the second lens is at least partially located within the FOV, and the waveguide is located between the first lens and the second lens.

16. The lens assembly according to claim 15, wherein the first lens is located farther from the eye than the second lens when providing the FOV.

17. The lens assembly according to claim 15, further comprising a third film located on a third surface of the second lens, wherein the second lens have the third surface and a fourth surface that are opposite to each other, the third film comprises a third antenna electrode, and the third antenna electrode is at least partially located within the FOV.

18. The lens assembly according to claim 17, wherein the third antenna electrode serves as:
another part of the first antenna;
another part of the second antenna, in a case that the lens assembly comprises the second film; or
at least a part of a third antenna.

19. The lens assembly according to claim 17, wherein the first antenna electrode and the third antenna electrode do not overlap in a direction of the eye perceiving the FOV.

20. A wireless electronic device, comprising:
at least one lens assembly, each of which is the lens assembly according to claim 1.

21. The wireless electronic device according to claim 20, further comprising:
housing configured to fix or accommodate the at least one lens assembly, wherein a whole of the housing is made of a conductive material.

22. (canceled)

23. The wireless electronic device according to claim 20, wherein the first antenna of one of the at least one lens assembly and the first antenna of another of the at least one lens assembly are configured to transmit or receive wireless signals of different frequency bands.
